(19) United States
(12) Patent Application Publication
(10) Pub. No.: US 2006/0124895 A1
(43) Pub. Date: Jun. 15, 2006

(54) Hydrogel, which can be photostructured in contact exposure and which has linker groups

(76) Inventors: Hans-Dieter Feucht, Renningen (DE); Walter Gumbrecht, Herzogenaurach (DE)

Correspondence Address: HARNESS, DICKEY & PIERCE, P.L.C., P.O.BOX 8910, RESTON, VA, 20195, US

(21) Appl. No.: 10/523,932

(22) PCT Filed: Jul. 23, 2003
(86) PCT No.: PCT/DE03/02482

§ 371 Date: Sep. 29, 2005

(30) Foreign Application Priority Data
Aug. 8, 2002 (DE) 102 36 460.5

(51) Int. Cl. C09K 19/38; C09K 19/52

(52) U.S. Cl. 252/299.01

(57) ABSTRACT

A photostructurable liquid composition is for producing a hydrogel layer based on polyacrylamide. The composition, in addition to containing the monomer precursor of the polyacrylamide, the cross-linking agent and the photoinitiator, contains at least one film former, at least one comonomer having reactive linker groups, and at least one softener.

This application is the national phase under 35 U.S.C. § 371 of PCT International Application No. PCT/DE2003/002482 which has an International filing date of Jul. 23, 2003, which designated the United States of America and which claims priority on German Patent Application number DE 102 36 460.5 filed Aug. 8, 2002, the entire contents of which are hereby incorporated herein by reference.

### FIELD OF THE INVENTION

The invention generally relates to a photostructurable liquid composition for producing hydrogels based on polyacrylamide.

### BACKGROUND OF THE INVENTION

Biochips are increasingly used in modern biological analysis and in medical diagnostics. Biochips are mainly planar carrier systems made of glass or plastic, the surface of which is provided with a two-dimensional detector layer that includes biological detection molecules. A known example of a biochip of this kind is the optically-readable DNA chip, described by F. Hänel, H. P. Saluz in BIOforum 9/99, pages 504-507.

To increase the sensitivity of such biochips and to optimize the reproducibility of the measuring results, the use of three-dimensional immobilizing layers for the biological detection molecules is useful. Therefore, Schleicher & Schuell GmbH use a three-dimensional immobilizing layer for a product called FAST™ Slides DNA-Chips in which capture oligos are immobilized in a three-dimensional nitrocellulose membrane (Schleicher & Schuell, BioMolecular Screening, Catalog 2001 (int. edt.)).

A problem with the technical realization of suitable immobilizing layers is mainly the requirement for a cost-effective method for applying the layer to the chips or to transducer systems. In a favorable method, the immobilizing systems of liquid precursors are dripped onto a suitable underlay, dispensed onto it, applied by centrifuge or printed on. Thermal polymerization or cross-linking, drying processes or photochemical polymerization or cross-linking processes are, for example, chosen to solidify the layers.

For an application of this kind, Ph. Arquint describes a photo cross-linked hydrogel based on a cross-linked polyacrylamide (“Integrated Blood Gas Sensor for pO2, pCO2 and pH based on Silicon Technology (Dissertation, Ph. Arquint, Uni Neuchatel, Switzerland, 1994).

Hydrogels play an important role in the chemical and/or biochemical analysis, and also particularly in the realization of chemo- and bio-sensors. They are also used to realize an aqueous environment in a mechanically stable form while at the same time guaranteeing an exchange of materials with a predominantly aqueous environment. The water content, swelling behavior, mechanical stability etc. of the hydrogels can be varied over a wide range by the choice of the chemical composition, such as network chemistry, mesh size and hydrophilicity.

The application of hydrogels for microstructure technology is particularly attractive. In this case, hydrogels in layer thicknesses of less than a few μm on transducer structures serve as microchemical reaction spaces in which aqueous chemistry can take place. Transducer structures are electrical, e.g. thin-film noble metal electrodes on a silicon substrate, or optical transducers, for example on glass or plastic surfaces.

In his dissertation, Ph. Arquint describes a method whereby polyacrylamide hydrogels are applied to silicon wafers using methods that are approximately semiconductor compatible and are photostructured. The described technology has, however, critical problems.

The layer of hydrogel precursor applied to the silicon wafer is still liquid, or even very sticky, at the time of exposure so that a direct method of contact exposure such as is normally used in semiconductor technology is not possible. Contact exposure means that the glass mask, the structure of which is to be transferred to the photosensitive layer by the photoprocess, is placed directly on this layer. The quality of the photo-cross-linkable layer must therefore be such that the glass mask (glass coated with chrome) can again be easily removed from the exposed layer after the exposure process, without damaging the layer. This is not possible with the system described by Arquint.

A further disadvantage of the system described by Arquint, i.e. of the hydrogel precursor is that no reactive linker groups are available in the cross-linked layer, with the aid of which chemical or biological detection molecules can be coupled for analytical applications.

### SUMMARY OF THE INVENTION

An object of an embodiment of the invention is to alleviate or even remove at least one of the disadvantages of the present prior art. An object may be to provide a hydrogel precursor for the production of a hydrogel layer by use of photostructuring using contact exposure, that also has reactive linker groups.

An embodiment of the invention may achieve an objective by using the basic components of the polyacrylamide hydrogels described by Arquint, such as acrylamide, acryl- or methacryl-based cross-linking molecules and photoinitiators, by introducing other components that enable a non-sticky hydrogel precursor, which can be photostructured in contact exposure, with additional reactive linker groups to be produced.

An object of an embodiment of the invention may be to provide a photostructurable liquid composition for the production of a hydrogel layer based on polyacrylamide that includes, in addition to the monomer precursor of the polyacrylamide, the cross-linking agent and the photoinitiator, at least one film former, at least one comonomer with reactive linker groups and at least one softener.

### DETAILED DESCRIPTION OF THE EXEMPLARY EMBODIMENTS

After the layer has been produced and photostructuring has taken place, a hydrogel that can be swelled using water is obtained, that contains reactive linker groups for immobilization of chemical or biological detection molecules for analytical applications and guarantees the exchange of materials with a predominantly aqueous environment.

The film former is preferably a water-soluble polymer and chosen from the group consisting of polyvinylpyrrolidone, polyacrylamide, and/or polyhydroxyethylmethacrylate.

Varying the amount of film former in the composition provides a parameter for setting the mesh size of the hydrogel.

The comonomer with reactive linker groups is preferably chosen from the group consisting of maleic anhydride and/or glycidyl(meth)acrylate. These structures are particularly useful for linking or coupling functions of chemical and/or biological molecules.

The composition in accordance with an embodiment of the invention preferably has a softener chosen from di- and/or triethyleneglycol. By optimizing the di- and/or triethyleneglycol content, the polymerization behavior of the dried precursor layer can be improved without the layer sticking. The polyacrylamide arrangement is based on acrylamide, methylenebisacrylamide and/or dimethacrylic-acid esters, such as tetraethyleneglycoldimethacrylate.

The composition i's preferably present in a polar water-miscible solvent. Dimethylformamide is particularly preferred. By varying the solvent and/or the amount of solvent, the viscosity of the system can be set.

The following composition of a hydrogel precursor can be seen as an example to illustrate an embodiment of the invention.

750 mg acrylamide

25 mg methylenebisacrylamide

300 mg glycidylmethacrylate

25 mg 2,2,-dimethoxy-2-phenylacetophenone

500 mg polyvinylpyrrolidone

150 mg triethyleneglycol

1 ml dimethylformamide

The solution can be applied to a substrate, for example a silicon wafer, by using a conventional lacquer centrifuge. To improve the adhesion, conventional additives can be used, or the wafer can be pretreated (see Arquint, loc cit.). The layer applied by centrifuge is then dried in a pre-bake stage and exposed by placing the mask in direct contact using a conventional contact exposure method. The development of areas that are not cross-linked and the extraction of cross-linked structures, i.e. the removal of auxiliary components, non-cross-linked monomers and soluble photoinitiator products, can be achieved, for example, by using water or solvents containing water.

The composition for production of a hydrogel layer, such as is required here, has a miscibility of the components used over a widely-variable mixing ratio, a good adjustability of the viscosity, a good suitability for centrifuge application and a good film formation. After the hydrogel films have dried, a non-stick film surface results. The film layer has a sufficient transparency to light for photoinitiation. The density of the cross-linking and the suitability for swelling in water can be adjusted by varying the amount of the cross-linking agent and the amount of film former used. After photostructuring, the auxiliary components such as film former and softener can be easily washed out. The adhesion to the substrate surface can be increased by using conventional adhesion-promoting systems, e.g. based on silane.

Exemplary embodiments being thus described, it will be obvious that the same may be varied in many ways. Such variations are not to be regarded as a departure from the spirit and scope of the present invention, and all such modifications as would be obvious to one skilled in the art are intended to be included within the scope of the following claims.

1. Photostructurable liquid composition for the production of a hydrogel layer based on polyacrylamide, comprising: a monomer precursor of the polyacrylamide;
a cross-linking agent;
a photoinitiator;
at least one film former;
at least one comonomer with reactive linker groups; and
at least one softener.

2. Composition in accordance with claim 1, wherein the film former is a water-soluble polymer.

3. Composition in accordance with claim 2, wherein the water-soluble polymer is chosen as a film former from the group consisting of polyvinylpyrrolidone, polyacrylamide and polyhydroxyethylmethacrylate.

4. Composition in accordance with claim 1, wherein the comonomer with reactive linker groups is chosen from the group consisting of maleic anhydride and glycidyl(meth)acrylate.

5. Composition in accordance with claim 1, wherein the softener is chosen from the group consisting of mono-, di- and triethyleneglycol.

6. Composition in accordance with claims 1, wherein the polyacrylamide arrangement is based on at least one of acrylicamide, methylenebisacrylamide and dimethacrylic-acid esters.

7. Composition in accordance with claim 1, wherein the composition is present in a polar water-miscible solvent.

8. A method, comprising:
using a composition in accordance with claim 2, for the production of a hydrogel using photostructuring by contact exposure.

9. A method, comprising:
using a composition in accordance with claim 1, for the production of an immobilizing layer for biomolecules on a transducer surface.

10. Composition in accordance with claim 2, wherein the water-soluble polymer is chosen as a film former from at least one of polyvinylpyrrolidone, polyacrylamide and polyhydroxyethylmethacrylate.

11. Composition in accordance with claim 2, wherein the comonomer with reactive linker groups is chosen from the group consisting of maleic anhydride and glycidyl(meth)acrylate.

12. Composition in accordance with claim 1, wherein the comonomer with reactive linker groups is chosen from at least one of maleic anhydride and glycidyl(meth)acrylate.

13. Composition in accordance with claim 2, wherein the comonomer with reactive linker groups is chosen from at least one of maleic anhydride and glycidyl(meth)acrylate.

14. Composition in accordance with claim 1, wherein the softener includes at least one of mono-, di- and triethyleneglycol.

15. A polar water miscible solvent, comprising the composition in accordance with claim 1.
